(19) United States
(12) Patent Application Publication
(10) Pub. No.: US 2025/0207216 A1
(43) Pub. Date: Jun. 26, 2025

(54) TWIP STEEL SHEET HAVING AN AUSTENITIC MATRIX

(71) Applicant: ARCELORMITTAL, Luxembourg (LU)

(72) Inventors: Colin SCOTT, Brantford (CA); Thierry IUNG, Jarny (FR); Marie-Christine THEYSSIER, Metz (FR)

(73) Assignee: ARCELORMITTAL, Luxembourg (LU)

(21) Appl. No.: 19/076,070

(22) Filed: Mar. 11, 2025

Related U.S. Application Data
(63) Continuation of application No. 16/302,992, filed on Nov. 19, 2018, now abandoned.

(51) Int. Cl. C21D 9/46; B32B 15/01; C21D 6/00; C21D 8/02; C21D 8/04; C22C 38/00; C22C 38/02; C22C 38/04; C22C 38/06; C22C 38/08; C22C 38/12; C22C 38/14; C22C 38/16; C22C 38/20; C22C 38/22; C22C 38/24; C22C 38/28; C22C 38/32; C22C 38/34; C22C 38/38; C22C 38/42; C22C 38/44; C22C 38/46; C22C 38/58; C23C 2/02; C23C 2/06; C23C 2/12; C23C 2/40; C23C 28/02

(52) U.S. Cl. CPC C21D 9/46; B32B 15/012; B32B 15/013; C21D 6/001; C21D 6/004; C21D 6/005; C21D 6/008; C21D 8/0205; C21D 8/0236; C21D 8/0268; C21D 8/0468; C22C 38/001; C22C 38/002; C22C 38/02; C22C 38/04; C22C 38/06; C22C 38/08; C22C 38/12; C22C 38/14; C22C 38/16; C22C 38/20; C22C 38/22; C22C 38/24; C22C 38/28; C22C 38/32; C22C 38/34; C22C 38/38; C22C 38/42; C22C 38/44; C22C 38/46; C22C 38/58; C23C 2/02; C23C 2/0224; C23C 2/06; C23C 2/12; C23C 2/40; C23C 28/021; C23C 28/023; C23C 28/025; B21B 2201/16; B21B 2265/14; C21D 2211/001; C21D 2211/004

(57) ABSTRACT

A cold rolled and recovered TWIP steel sheet is provided having an austenitic matrix including by weight: 0.71<C<1.2%, 13.0≤Mn<25.0%, S≤0.030%, P≤0.080%, N≤0.1%, 0.1≤Si≤3.0%, 0.1≤V≤2.50%, and on a purely optional basis, one or more elements such as Cu≤5.0%, Al≤4.0%, Nb≤0.5%, B≤0.005%, Cr≤1.0%, Mo≤0.40%, Ni≤1.0%, Ti≤0.5%, 0.06≤Sn≤0.2%, the remainder of the composition being made of iron and inevitable impurities resulting from elaboration.

This is a continuation of U.S. patent application Ser. No. 16/302,992, filed on Nov. 19, 2018, now published as U.S. 2019/0218639 A1, which is a national phase of International Patent Application PCT/IB2017/000623, filed on May 23, 2017, which claims priority to PCT/IB2016/000700, filed on May 24, 2016. All of the above are hereby incorporated by reference herein.

### FIELD OF THE INVENTION

The present invention relates to a cold-rolled and recovered TWIP steel sheet having an austenitic matrix and a method for the manufacture of this cold-rolled and recovered TWIP steel. The invention is particularly well suited for the manufacture of automotive vehicles.

### BACKGROUND

With a view of saving the weight of vehicles, it is known to use high strength steels for the manufacture of automobile vehicle. For example for the manufacture of structural parts, mechanical properties of such steels have to be improved. However, even if the strength of the steel is improved, the elongation and therefore the formability of high steels decreased. In order to overcome these problems, twinning induced plasticity steels (TWIP steels) having good formability have appeared. Even if these products show a very good formability, mechanical properties such as Ultimate tensile strength (UTS) and yield stress (YS) may not be high enough to fulfill automotive application.

The patent application US20060278309 discloses a hot-rolled austenitic iron/carbon/manganese steel sheet, the strength of which is greater than 900 MPa, the product (strength (in MPa)*elongation at fracture (in %)) of which is greater than 45000 and the chemical composition of which comprises, the contents being expressed by weight: 0.5%≤C≤0.7%, 17%≤Mn≤24%, Si≤3%, Al≤0.050%, S≤0.030%, P≤0.080%, N≤0.1%, and, optionally, one or more elements such that: Cr≤1%, Mo≤0.40%, Ni≤1%, Cu≤5%, Ti≤0.50%, Nb≤0.50% and V≤0.50%, the composition further comprising iron and inevitable impurities resulting from the smelting, the recrystallized fraction of the steel being greater than 75%, the surface fraction of precipitated carbides of the steel being less than 1.5% and the mean grain size of the steel being less than 18 μm.

### SUMMARY OF THE INVENTION

However, the strength of this austenitic steel sheet is really low. Indeed, in the examples, the strength is of 1130 MPa in the range of the invention.

Thus, an object of the present invention is to solve the above drawbacks by providing a TWIP steel having a high strength, an excellent formability and elongation. It aims to make available also an easy to implement method in order to obtain this TWIP steel. This object is achieved by providing a cold rolled and recovered TWIP steel sheet in accordance with an emdobiment of the present invention having an austenitic matrix comprising by weight: 0.71<C<1.2%, 13.0≤Mn<25.0%, S≤0.030%, P≤0.080%, N≤0.1%, 0.1≤Si≤3.0%, 0.1≤V≤2.50%, and on a purely optional basis, one or more elements such as Cu≤5.0%, Al≤4.0%, Nb≤0.5%, B≤0.005%, Cr≤1.0%, Mo≤0.40%, Ni≤1.0%, Ti≤0.5%, 0.06≤Sn≤0.2%, the remainder of the composition being made of iron and inevitable impurities resulting from elaboration.

Another object is achieved by providing a method for producing a TWIP steel sheet in accordance with another embodiment of the present invention, comprising:
A. feeding a slab having a composition comprising by weight: 0.71<C<1.2%, 13.0≤Mn<25.0%, S≤0.030%, P≤0.080%, N≤0.1%, 0.1≤Si≤3.0%, 0.1≤V≤2.50%, and on a purely optional basis, one or more elements such as Cu≤5.0%, Al≤4.0%, Nb≤0.5%, B≤0.005%, Cr≤1.0%, Mo≤0.40%, Ni≤1.0%, Ti≤0.5%, 0.06≤Sn≤0.2%, the remainder of the composition being made of iron and inevitable impurities resulting from elaboration,
B. reheating the slab at a temperature above 1000° C. and hot rolling it with a final rolling temperature of at least 850° C. to provide a hot rolled slab,
C. coiling the hot rolled slab at a temperature below or equal to 580° C. to provide a coiled slab,
D. first cold-rolling the coiled slab with a reduction rate between 30 and 70% to provide a first cold rolled slab,
E. recrystallization annealing the first cold rolled slab between 700 and 900° C. to provide an annealed slab,
F. second cold-rolling the annealed slab with a reduction rate between 1 to 50% to provide a second cold rolled slab, and
G. recovery heat treating the second cold rolled slab.

Other characteristics and advantages of the invention will become apparent from the following detailed description of the invention.

### DETAILED DESCRIPTION

The following terms will be defined:
all percentage “%” in the steel composition are defined by weight,
UTS: ultimate tensile strength (MPa) and
TE: total elongation (%).

In accordance with an embodiment of the present invention, a cold-rolled and recovered TWIP steel sheet having an austenitic matrix comprising by weight:
0.71<C<1.20%,
13.0≤Mn<25.0%,
S≤0.030%,
P≤0.080%,
N≤0.10%,
0.1≤V≤2.50%,

and on a purely optional basis, one or more elements such as
Cu≤5.0%,
Al≤4.0%,
Nb≤0.50%,
B≤0.0050%,
Cr≤1.0%,
Mo≤0.40%,
Ni≤1.0%,
Ti≤0.50%,
0.06≤Sn≤0.2%,
   the remainder of the composition being made of iron and inevitable impurities resulting from the elaboration.

Without willing to be bound by any theory, it seems that the TWIP steel sheet according to the invention allows for an improvement of the mechanical properties thanks to this specific composition. Indeed, it is believed that the above composition comprising the high amount of C allows for an improvement of, among others, ultimate tensile strength.

Regarding the chemical composition of the steel, C plays an important role in the formation of the microstructure and the mechanical properties. It increases the stacking fault energy and promotes stability of the austenitic phase. When combined with a Mn content ranging from 13.0 to 25.0% by weight. In case there are vanadium carbides, a high Mn content may increase the solubility of vanadium carbide (VC) in austenite. However, for a C content above 1.2%, there is a risk that the ductility decreases due to for example an excessive precipitation of (Fe,Mn)₃C cementite. Preferably, the carbon content is between 0.71 and 1.1%, more preferably between 0.8 and 1.0% and advantageously between 0.9 and 1.0% by weight so as to obtain sufficient strength combined optionally with optimum carbide or carbonitride precipitation.

Mn is also an essential element for increasing the strength, for increasing the stacking fault energy and for stabilizing the austenitic phase. If its content is less than 13.0%, there is a risk of martensitic phases forming, which very appreciably reduce the deformability. Moreover, when the manganese content is greater than 25.0%, formation of twins is suppressed, and accordingly, although the strength increases, the ductility at room temperature is degraded. Preferably, the manganese content is between 15.0 and 24.0%, more preferably between 17.0 and 24.0% so as to optimize the stacking fault energy and to prevent the formation of martensite under the effect of a deformation. Moreover, when the Mn content is greater than 24.0%, the mode of deformation by twinning is less favored than the mode of deformation by perfect dislocation glide.

Al is a particularly effective element for the deoxidation of steel. Like C, it increases the stacking fault energy which reduces the risk of forming deformation martensite, thereby improving ductility and delayed fracture resistance. However, Al is a drawback if it is present in excess in steels having a high Mn content, because Mn increases the solubility of nitrogen in liquid iron. If an excessively large amount of Al is present in the steel, the N, which combines with Al, precipitates in the form of aluminum nitrides (AlN) that impede the migration of grain boundaries during hot conversion and very appreciably increases the risk of cracks appearing in continuous casting. In addition, as will be explained later, a sufficient amount of N must be available in order to form fine precipitates, essentially carbonitrides. Preferably, the Al content is below or equal to 2%. When the Al content is greater than 4.0%, there is a risk that the formation of twins is suppressed decreasing the ductility. Preferably, the amount of Al is above 0.1%.

Correspondingly, the nitrogen content must be 0.1% or less so as to prevent the precipitation of AIN and the formation of volume defects (blisters) during solidification. In addition, when elements capable of precipitating in the form of nitrides are present, such as vanadium, niobium, titanium, chromium, molybdenum and boron, the nitrogen content must not exceed 0.1%.

According to embodiments of the present invention, the amount of V is between 0.1 and 2.5%, preferably between 0.1 and 1.0%. Preferably, V forms precipitates. Advantageously, vanadium elements have a mean size below 7 nm, preferably between 0.2 and 5nm and are intragranular in the microstructure.

Silicon is also an effective element for deoxidizing steel and for solid-phase hardening. However, above a content of 3%, it reduces the elongation and tends to form undesirable oxides during certain assembly processes, and it must therefore be kept below this limit. Preferably, the content of silicon is below or equal to 0.6%.

Sulfur and phosphorus are impurities that embrittle the grain boundaries. Their respective contents must not exceed 0.030 and 0.080% so as to maintain sufficient hot ductility.

Some Boron may be added up to 0.005%, preferably up to 0.001%. This element segregates at the grain boundaries and increases their cohesion. Without intending to be bound to a theory, it is believed that this leads to a reduction in the residual stresses after shaping by pressing, and to better resistance to corrosion under stress of the thereby shaped parts. This element segregates at the austenitic grain boundaries and increases their cohesion. Boron precipitates for example in the form of borocarbides and boronitrides.

Nickel may be used optionally for increasing the strength of the steel by solution hardening. However, it is desirable, among others for cost reasons, to limit the nickel content to a maximum content of 1.0% or less and preferably between below 0.3%.

Likewise, optionally, an addition of copper with a content not exceeding 5% is one means of hardening the steel by precipitation of copper metal. However, above this content, copper is responsible for the appearance of surface defects in hot-rolled sheet. Preferably, the amount of copper is below 2.0%. Preferably, the amount of Cu is above 0.1%.

Titanium and Niobium are also elements that may optionally be used to achieve hardening and strengthening by forming precipitates. However, when the Nb or Ti content is greater than 0.50%, there is a risk that an excessive precipitation may cause a reduction in toughness, which has to be avoided. Preferably, the amount of Ti is between 0.040 and 0.50% by weight or between 0.030% and 0.130% by weight. Preferably, the titanium content is between 0.060% and 0.40 and for example between 0.060% and 0.110% by weight. Preferably, the amount of Nb is above 0.01% and more preferably between 0.070 and 0.50% by weight or 0.040 and 0.220%. Preferably, the niobium content is between 0.090% and 0.40% and advantageously between 0.090% and 0.200% by weight.

Chromium and Molybdenum may be used as optional element for increasing the strength of the steel by solution hardening. However, since chromium reduces the stacking fault energy, its content must not exceed 1.0% and preferably between 0.070% and 0.6%. Preferably, the chromium content is between 0.20 and 0.5%. Molybdenum may be added in an amount of 0.40% or less, preferably in an amount between 0.14 and 0.40%.

Furthermore, without willing to be bound by any theory, it seems that precipitates of vanadium, titanium, niobium, chromium and molybdenum can reduce the sensitivity to delayed cracking, and do so without degrading the ductility and toughness properties. Thus, at least one element may be chosen from titanium, niobium, chromium and molybdenum under the form of carbides, nitrides and carbonitrides.

Optionally, tin (Sn) is added in an amount between 0.06 and 0.2% by weight. without willing to be bound by any theory, it is believed that since tin is a noble element and does not form a thin oxide film at high temperatures by itself, Sn is precipitated on a surface of a matrix in an annealing prior to a hot dip galvanizing to suppress a pro-oxidant element such as Al, Si, Mn, or the like from being diffused into the surface and forming an oxide, thereby improving galvanizability. However, when the added amount of Sn is less than 0.06%, the effect is not distinct and an increase in the added amount of Sn suppresses the formation of selective oxide, whereas when the added amount of Sn exceeds 0.2%, the added Sn causes hot shortness to deteriorate the hot workability. Therefore, the upper limit of Sn is limited to 0.2% or less.

The steel can also comprise inevitable impurities resulting from the development. For example, inevitable impurities can include without any limitation: O, H, Pb, Co, As, Ge, Ga, Zn and W. For example, the content by weight of each impurity is inferior to 0.1% by weight.

Preferably, the mean size of grain of steel is up to 5 μm, preferably between 0.5 and 3 μm.

In a preferred embodiment, the steel sheet is covered by a metallic coating. The metallic coating can be an aluminum-based coating or a zinc-based coating.

Preferably, the aluminum-based coated comprises less than 15% Si, less than 5.0% Fe, optionally 0.1 to 8.0% Mg and optionally 0.1 to 30.0% Zn, the remainder being Al.

Advantageously, the zinc-based coating comprises 0.01-8.0% Al, optionally 0.2-8.0% Mg, the remainder being Zn.

For example, the coated steel is a galvannealed steel sheet obtained after an annealing step performed after the coating deposition.

In a preferred embodiment, the steel sheet has a thickness between 0.4 and 1 mm.

A method according to an embodiment the present invention for producing a TWIP steel sheet comprises the following steps:
A. feeding of a slab having the above composition,
B. Reheating such slab and hot rolling it,
C. A coiling step,
D. A first cold-rolling,
E. An recrystallization annealing,
F. A second cold-rolling and
G. A recovery heat treatment.

According to this embodiment of the present invention, the method may comprise the feeding step A) of a semi product, such as slabs, thin slabs, or strip made of steel having the composition described above, such slab is cast. Preferably, the cast input stock is heated to a temperature above 1000° C., more preferably above 1050° C. and advantageously between 1100 and 1300° C. or used directly at such a temperature after casting, without intermediate cooling.

The hot-rolling is then performed at a temperature preferably above 890° C., or more preferably above 1000° C. to obtain for example a hot-rolled strip usually having a thickness of 2 to 5 mm, or even 1 to 5 mm. To avoid any cracking problem through lack of ductility, the end-of-rolling temperature is preferably above or equal to 850° C.

After the hot-rolling, the strip has to be coiled at a temperature such that no significant precipitation of carbides (essentially cementite (Fe,Mn)₃C) occurs, something which would result in a reduction in certain mechanical properties. The coiling step C) is realized at a temperature below or equal to 580° C., preferably below or equal to 400° C.

A subsequent cold-rolling operation followed by a recrystallization annealing is carried out. These additional steps result in a grain size smaller than that obtained on a hot-rolled strip and therefore results in higher strength properties. Of course, it must be carried out if it is desired to obtain products of smaller thickness, ranging for example from 0.2 mm to a few mm in thickness and preferably from 0.4 to 4 mm. A hot-rolled product obtained by the process described above is cold-rolled after a possible prior pickling operation has been performed in the usual manner.

The first cold-rolling step D) is performed with a reduction rate between 30 and 70%, preferably between 40 and 60%.

After this rolling step, the grains are highly work-hardened and it is necessary to carry out a recrystallization annealing operation. This treatment has the effect of restoring the ductility and simultaneously reducing the strength. Preferably, this annealing is carried out continuously. Advantageously, the recrystallization annealing E) is realized between 700 and 900° C., preferably between 750 and 850° C., for example during 10 to 500 seconds, preferably between 60 and 180 seconds.

Then, a second cold-rolling step F) is realized with a reduction rate between 1 to 50%, preferably between 10 and 40% and more preferably between 20% and 40%. It allows for the reduction of the steel thickness. Moreover, the steel sheet manufactured according to the aforesaid method, may have increased strength through strain hardening by undergoing this re-rolling step. Additionally, this step induces a high density of twins improving thus the mechanical properties of the steel sheet.

After the second cold-rolling, a recovery step G) is realized in order to additionally secure high elongation and bendability of the re-rolled steel sheet. Recovery is characterized by the removal or rearrangement of dislocations in the steel microstructure while keeping the deformation twins. Both deformation twins and dislocations are introduced by plastic deformation of the material, such as rolling step.It is believed that the recovery step allows for an increase of the mechanical properties such as the elongation.

Thus, in addition to the high amount of C in the TWIP steel according to the present invention, a recovery step is performed allowing an improvement of notably the elongation. And, thanks to the combination of the specific TWIP steel and the method comprising the recovery step according to the present invention, it is possible to obtain a cold-rolled and recovered TWIP steel having a high mechanical resistance and a high elongation.

In a preferred embodiment, a recovery step G) is performed by heating the steel sheet at a temperature between 390 and 700° C. and preferably 410 and 700° C. in a batch annealing or a continuous annealing furnace. In this embodiment, a hot-dip galvanizing step H) can then be performed.

In another preferred embodiment, the recovery step G) is performed by hot-dip galvanization. In this case, the recovery step G) and the hot-dip galvanization are realized in the same time allowing cost saving and the increase of the productivity.

Preferably, the temperature of the molten bath is between 410 and 700° C. depending on the nature of the molten bath.

Advantageously, the steel sheet is dipped into an aluminum-based bath or a zinc-based bath. Preferably, the dipping into a molten bath is performed during 1 to 60 seconds, more preferably between 1 and 20 seconds and advantageously, between 1 to 10 seconds.

In a preferred embodiment, the aluminum-based bath comprises less than 15% Si, less than 5.0% Fe, optionally 0.1 to 8.0% Mg and optionally 0.1 to 30.0% Zn, the remainder being Al. Preferably, the temperature of this bath is between 550 and 700° C., preferably between 600 and 680° C.

In another preferred embodiment, the zinc-based bath comprises 0.01-8.0% Al, optionally 0.2-8.0% Mg, the remainder being Zn. Preferably, the temperature of this bath is between 410 and 550° C., preferably between 410 and 460° C.

The molten bath can also comprise unavoidable impurities and residuals elements from feeding ingots or from the passage of the steel sheet in the molten bath. For example, the optionally impurities are chosen from Sr, Sb, Pb, Ti, Ca, Mn, Sn, La, Ce, Cr, Zr or Bi, the content by weight of each additional element being inferior to 0.3% by weight. The residual elements from feeding ingots or from the passage of the steel sheet in the molten bath can be iron with a content up to 5.0%, preferably 3.0%, by weight.

Advantageously, the recovery step G) is performed between 1 second and 1 hour and 10 minutes, preferably between 30 seconds and 1hour and more preferably between 30 seconds and 30 minutes.

For example, an annealing step can be performed after the coating deposition in order to obtain a galvannealed steel sheet.

A TWIP steel sheet comprising an austenitic matrix having a high strength, an excellent formability and elongation is thus obtainable from the method according to the invention.

### EXAMPLE

In this example, TWIP steel sheets having the following weight composition were used:

| Trials | C % | Si % | Mn % | P % | % Cr | % Al | Cu % | % Ti | % V | % N | % Mo | % Ni |
|---|---|---|---|---|---|---|---|---|---|---|---|---|
| 1 | 0.583 | 0.226 | 21.9 | 0.03 | 0.183 | — | 0.031 | — | 0.206 | 0.0148 | 0.01 | 0.06 |
| 2* | 0.900 | 0.505 | 17.2 | 0.024 | — | — | — | — | 0.3 | 0.0192 | — | — |
| 3 | 0.579 | 0.208 | 22.87 | 0.02 | 0.114 | 0.002 | 0.162 | 0.005 | 0.007 | 0.0037 | — | — |
| 4* | 0.856 | 0.21 | 21.94 | 0.027 | 0.114 | 1.35 | 0.155 | 0.04 | 0.891 | 0.008 | | |
| 5* | 0.876 | 0.502 | 17.63 | 0.032 | 0.108 | 2.78 | 0.149 | — | 0.384 | 0.0061 | — | — |

*examples according to the present invention.

Firstly, the samples were heated and hot-rolled at a temperature of 1200° C. The finishing temperature of hot-rolling was set to 890° C. and the coiling was performed at 400° C. after the hot-rolling. Then, a 1^{st} cold-rolling was realized with a cold-rolling reduction ratio of 50%. Thereafter, a recrystallization annealing was performed at 850° C. during 180 seconds. Afterwards, a 2^{nd} cold-rolling was realized with a cold-rolling reduction ratio of 30%.

Finally, a recovery heat step was performed during 1 hour at 400° C. for Trials 1 and 2 in a batch annealing.

For Trials 3 to 5, a recovery heat treatment was performed during 60 seconds in total. The steel sheet was first prepared through heating in a furnace up to 625° C., the time spent between 460 and 625° C. being 54 seconds and then dipped into a zinc bath during respectively 6 s. The molten bath temperature was of 460° C.The following Table shows the mechanical properties of all Trials, after the recrystallization annealing E), after the second-rolling step F) and after the recovery step G).

| | After step E) | | After step F) | | After step G) | |
|---|---|---|---|---|---|---|
| | UTS | TE | UTS | TE | UTS | TE |
| Trials | (MPa) | (%) | (MPa) | (%) | (MPa) | (%) |
| 1 | 1139 | 53 | 1979 | 3.7 | 1977 | 7.4 |
| 2* | 1345 | 46.5 | 2247 | 1.4 | 2088 | 9.2 |
| 3 | 1087 | 62 | 1513 | 12.75 | 1418.5 | 27.95 |
| 4* | 1226 | 27.5 | 1828 | 3.55 | 1653.5 | 11.1 |
| 5* | 1100.5 | 36.05 | 1659.5 | 6.9 | 1515.5 | 15.25 |

Results show that Trials 2, 4 and 5, having a composition according to the invention have higher mechanical properties than Trials 1 and 3 having a composition outside the range of the invention. Indeed, the specific composition of the TWIP steel in addition to the method according to the present invention allows for a high UTS and a high TE.

What is claimed is:

1. A method for producing a TWIP steel sheet comprising:
A. feeding a slab having a composition comprising by weight:
0.71<C<1.2%,
13.0≤Mn<25.0%,
S≤0.030%,
P≤0.080%,
N≤0.1%,
0.1≤Si≤3.0%,
0.1≤V≤2.50%,
the remainder of the composition being made of iron and inevitable impurities resulting from elaboration;
B. reheating the slab at a temperature above 1000° C. and hot rolling it with a final rolling temperature of at least 850° C. to provide a hot rolled slab;
C. coiling the hot rolled slab at a temperature below or equal to 580° C. to provide a coiled slab,
D. first cold-rolling the coiled slab with a reduction rate between 30 and 70% to provide a first cold rolled slab;
E. recrystallization annealing the first cold rolled slab between 700 and 900° C. to provide an annealed slab;
F. second cold-rolling the annealed slab with a reduction rate between 1 to 50% to provide a second cold rolled slab; and
G. rearranging dislocations in a microstructure of the second cold rolled slab by recovery heat treating the second cold rolled slab for a duration different from a duration of the recrystallization annealing and thereby providing the recovered TWIP steel sheet, said recovery heat treating comprising a hot-dip galvanization in a molten bath at a temperature between 410 and 700° C. for 1 to 60 seconds.

2. The method according to claim 1, wherein said recovery treating, prior to the hot-dip galvanization further comprises heat treating the second cold rolled slab in a batch annealing or a continuous annealing furnace at a temperature between 390 and 700° C. for a duration between 30 seconds and 1 hour.

3. The method according to claim 1, wherein the composition further comprises one or more of
Cu≤5.0%,
Al≤4.0%,
Nb≤0.5%,
B≤0.005%,
Cr≤1.0%,
Mo≤0.40%,
Ni≤1.0%,
Ti≤0.5%, and/or
0.06≤Sn≤0.2%.

4. The method according to claim 1, wherein the TWIP steel sheet has an austenitic matrix after the recovery step G).

5. The method according to claim 1, wherein the amount of C is between 0.71 and 1.1%.

6. The method according to claim 5, wherein the amount of C is between 0.80 and 1.0%.

7. The method according to claim 6, wherein the amount of C is between 0.9 and 1.0%.

8. The method according to claim 1, wherein the amount of Cu is below 2.0%.

9. The method according to claim 1, wherein the amount of Si is below or equal to 0.6%.

10. The method according to claim 2, wherein the Al content is below or equal to 2%.

11. The method according to claim 1, wherein the amount of V is between 0.1 and 1.0%.

12. The method according to claim 1, wherein the second cold rolling has a reduction between 20-40%.

13. The method according to claim 1, wherein the composition is free from Al or comprises 1.35%≤Al≤4.0%.

14. The method according to claim 1, wherein the composition comprises 0.1<Cu<1.155%.

15. The method according to claim 14, wherein the composition is free from Al or comprises 1.35%≤Al≤4.0%.

16. A method for producing a recovered TWIP steel sheet comprising:
A. feeding a slab having a composition comprising by weight:
0.71<C<1.2%,
13.0≤Mn<25.0%,
1.35%≤Al≤4.0%,
0.1<Cu<1.155%,
S≤0.030%,
P≤0.080%,
N≤0.1%,
0.1≤Si≤3.9%,
0.1≤V≤2.50%,
the remainder of the composition being made of iron and inevitable impurities resulting from elaboration;
B. reheating the slab at a temperature above 1000° C. and hot rolling it with a final rolling temperature of at least 850° C. to provide a hot rolled slab;
C. coiling the hot rolled slab at a temperature below or equal to 580° C. to provide a coiled slab,
D. first cold-rolling the coiled slab with a reduction rate between 30 and 70% to provide a first cold rolled slab;
E. recrystallization annealing the first cold rolled slab between 700 and 900° C. to provide an annealed slab;
F. second cold-rolling the annealed slab with a reduction rate between 1 to 50% to provide a second cold rolled slab; and
G. recovery heat treating the second cold rolled slab, said recovery heat treating performed between 390 and 700° C., in a batch annealing or a continuous annealing furnace between 30 seconds and 1 hour, and then in a molten bath at a temperature between 410 and 700° C. for 1 to 60 seconds.

17. The method according to claim 16, wherein the recovery heat treating is for 60 seconds in total.

18. A method for producing a recovered TWIP steel sheet comprising:
A. feeding a slab having a composition comprising by weight:
0.71<C<1.2%,
13.0≤Mn<25.0%,
0.1<Cu<1.155%,
S≤0.030%,
P≤0.080%,
N≤0.1%,
0.1≤Si≤3.0%,
0.1≤V≤2.50%,
the remainder of the composition being made of iron and inevitable impurities resulting from elaboration, wherein the composition if free from Al;
B. reheating the slab at a temperature above 1000° C. and hot rolling it with a final rolling temperature of at least 850° C. to provide a hot rolled slab;
C. coiling the hot rolled slab at a temperature below or equal to 580° C. to provide a coiled slab,
D. first cold-rolling the coiled slab with a reduction rate between 30 and 70% to provide a first cold rolled slab;
E. recrystallization annealing the first cold rolled slab between 700 and 900° C. to provide an annealed slab;
F. second cold-rolling the annealed slab with a reduction rate between 1 to 50% to provide a second cold rolled slab; and
G. recovery heat treating the second cold rolled slab, said recovery heat treating performed between 390 and 700° C., in a batch annealing or a continuous annealing furnace for a duration between 30 seconds and 1 hour.

19. The method according to claim 18, wherein said recovery heat treating further comprises, after the batch annealing or the continuous annealing, dipping the second cold rolled slab in a molten bath for 1 to 60 seconds.

20. The method according to claim 19, wherein the recovery heat treating is for 60 seconds.

21. The method according claim 16, wherein the recovered TWIP steel sheet has a total elongation between 9.2 and 15.25%, and ultimate tensile strength between 1515.5 and 2088 MPa.

22. The method according claim 1, wherein the recovered TWIP steel sheet has a total elongation between 9.2 and 15.25%, and ultimate tensile strength between 1515.5 and 2088 MPa.

23. The method according claim 16, wherein the recovered TWIP steel sheet has a total elongation between 9.2 and 15.25%, and ultimate tensile strength between 1515.5 and 2088 MPa.
